(19) United States
(12) Patent Application Publication
(10) Pub. No.: US 2007/0133456 A1
(43) Pub. Date: Jun. 14, 2007

(54) Method and System for Receiving Multimedia Broadcast/Multicast Service Control Information, and UE Thereof

(75) Inventor: Yingzhe Ding, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Huawei Technologies Co., Ltd., Shenzhen (CN)

(21) Appl. No.: 11/613,099

(22) Filed: Dec. 19, 2006

Related U.S. Application Data
(63) Continuation of application No. PCT/CN05/01906, filed on Nov. 11, 2005.

(30) Foreign Application Priority Data
Mar. 28, 2005 (CN) 200510056880.5

(51) Int. Cl. H04Q 7/00; H04L 12/56

(52) U.S. Cl. 370/328; 370/401

(57) ABSTRACT

A method for receiving Multimedia Broadcast/Multicast Service (MBMS) control information includes: a network side transfers a system information block in a broadcast channel, the system information block includes Radio Link Control Layer (RLC) configuration information; a User Equipment (UE) selects a new cell, and obtains the available RLC configuration information which is available to the new cell, and re-establishes an RLC receiving entity according to the available RLC configuration information. A method for receiving MBMS control information, includes: a network side transferring a system information block in a broadcast channel, the system information block including RLC configuration information; receiving, a UE, the RLC configuration information, and if there is out-of-sequence delivery configuration information within the RLC configuration information, configuring an RLC receiving entity according to the received out-of-sequence delivery configuration information. The invention also provides a system for receiving MBMS control information, and a UE thereof.

This application is a continuation of International Patent Application No. PCT/CN2005/001906, filed Nov. 11, 2005, which claims priority to Chinese Patent Application No. 200510056880.5, filed Mar. 28, 2005, all of which are hereby incorporated by reference.

### FIELD OF THE TECHNOLOGY

The present invention relate to the technique of information receiving, and more particularly to a method and a system for receiving Multimedia Broadcast/Multicast Service (MBMS) control information, and a User Equipment (UE) thereof.

### BACKGROUND OF THE INVENTION

Multicast and broadcast are the techniques for transferring data from one data source to a plurality of targets. In conventional mobile communication networks, Cell Multicast Service or Cell Broadcast Service (CBS) allows the low bit rate data to be transferred to all subscribers through broadcast channels shared by cells; this kind of service belongs to the message service.

Nowadays, simple telephone and message services can no longer meet subscribers' requirements for mobile communication; sharp development of Internet has brought out many new diversified mobile multimedia services. Wherein, some mobile multimedia services such as Video on demand (VOD), TV Broadcasting, Video Conference, online education and interactive game etc., require that several subscribers receive an identical data simultaneously. Compared with common data services, these mobile multimedia services have the properties of large data flow, long duration and delay-sensitivity, etc. The current Internet protocol (IP) multicast and broadcast techniques can only be applied to wired IP communication network rather than mobile communication networks, because the mobile communication network has special network architecture, function entity and radio interface, which are different from those of wired communication IP network.

In order to make full use of Mobile Communication network resources, 3rd Generation Partnership Project (3GPP) introduces the concept of multicast and broadcast (MBMS), and thereby provides Point to Multipoint (PTM) service where one data source transfers data to a plurality of targets in Mobile Communication network, in order to share network resources and increase Utilization Ratio of network resources especially air interface resource. The MBMS defined by 3GPP can implement not only multicast and broadcast of low speed messages such as plain text, but also multicast and broadcast of high speed multimedia services, which undoubtedly meets the requirements of future mobile data development.

FIG. 1 is a schematic diagram illustrating architecture of a radio network that supports Broadcast/Multicast service, as shown in FIG. 1, an entity of the radio network that supports Broadcast/Multicast service is a Broadcast/Multicast service server (BM-SC) 101, and the BM-SC 101 connect to a TPF GGSN (Gateway GPRS Support Node) 102 through a Gmb interface or a Gi interface, one BM-SC 101 can connect to a plurality of TPF GGSNs 102; the TPF GGSN 102 connect to a SGSN (Serving GPRS Support Node) 103 via a Gn/Gp interface, one GGSN 102 can connect to a plurality of SGSNs 103; the SGSN 103 can connect to a UTRAN (Universal Terrestrial Radio Access Network) 104 of Universal Mobile Telecommunication System (UMTS) through an Iu interface, and the UTRAN 104 connects to a UE 106 via a Uu interface, the SGSN 103 can also connect to a GSM (Global System of Mobile communication) GERAN (GSM/EDGE Radio Access Network)105 through the Iu/Gb interface, and the GERAN 105 further connects to a User Equipment (UE)107 via a Um interface. Wherein, both the GGSN and the SGSN are nodes of Core Network (CN) in the radio network.

According to the FIG. 1, in order to support MBMS service, the Broadcast/Multicast Service Center, i.e. the BM-SC 101 is introduced into 3G Mobile Communication system, the BM-SC 101 is the entrance of the content providers, which can be used for authorization and initiating MBMS bearer service in the radio networks and transferring the MBMS content according to a preset schedule. The functions related to MBMS have been added into the function entities such as UE, UTRAN, GERAN, SGSN and GGSN etc.

MBMS includes a multicast mode and a broadcast mode, wherein, the multicast mode requires users to subscribe to a Multicast group, activate the services and generate the corresponding charge information. AS the service requirement of the multicast mode and broadcast mode is different, the operation is different in the two modes, as shown in FIG. 2 and FIG. 3. FIG. 2 is a schematic flowchart illustrating operation in the MBMS Multicast mode, while FIG. 3 is a schematic flowchart illustrating operation in the MBMS Broadcast mode.

As shown in FIG. 2, the operation in the MBMS Multicast service includes: Subscription, Service announcement, Joining, Session Start, MBMS notification, Data transfer, Session Stop and Leaving. Wherein, a UE can pre-subscribe desired MBMS services in the Subscription step; the BM-SC can announce currently available services in the Service announcement step; Joining step is the activating procedure of the MBMS multicast service, during the joining step, the UE informs the network its willingness to be a member of current multicast group and accepts multicast data of corresponding services, the joining step generates MBMS UE context in the network and US that joined the multicast group to record the USE information; in Session Start step, the BM-SC prepares data for transferring, and informs the network to establish bearer resource related to the CN and the RAN; during the MBMS notification step, the UE is notified that the MBMS multicast session will start; during Data transfer step, the BM-SC transfers data to the UE through the bearer resource established in the Session Start step, the MBMS service has two modes when transferring between UTRAN and UE: Point To Multipoint (PTM) mode and Point To Point (PTP) mode, wherein, in the PTM mode, identical data is transferred through MTCH(MBMS PTM service channel), and all UEs subscribing to the Multicast service or interesting in Broadcast service can receive it. In the PTP mode, the data is transferred via DTCH (dedicated service channel) and only one corresponding UE can receive it; in the Session Stop step, the bearer resource established in Session Start step is released; in the Leaving step, the subscribers in the group leave the multicast group, not accept Multicast data, and the corresponding MBMS UE context is deleted in the step.

Referring to FIG. 3, processing procedure of the MBMS Broadcast service is similar to it of the MBMS Multicast service; however, the Subscription process, the Joining process and the Leaving process are not performed.

In MBMS PTM transfer mode, the relevant radio control information includes service information, access information, radio bearer information and Frequency Layer Convergence (FLC) information, which are transferred by Radio Resource Control (RRC) through logical channel, such as MBMS PTM Control Channel (MCCH). The MCCH information is transferred based on fixed scheduling, and for improving reliability, the UTRAN repeats transferring the MCCH information. FIG. 4 is a schematic illustrating transfer scheduling of the MCCH information, as shown in FIG. 4, the square blocks in the FIG. 4 is the MCCH information. The MCCH information is divided into Critical Information (Critical Info) and non-critical Information, wherein, the Critical Information includes MBMS neighboring cell information, the MBMS service information and MBMS radio bearer information. The complete MCCH information can be transferred repeatedly in a repetition period during which the MCCH information is transferred. The content transferred in one repetition period can not be modified. The MCCH information can be modified when it is transferred firstly in a modification period. The length of a modification period is defined as N times of the repetition period, N is an integer. The MCCH information is modified in each modification period. Non-critical Information refers to MBMS access information that needs no transfer repeatedly and can be modified at any time. The MBMS access information can be transferred periodically in an access information cycle, wherein, the length of the access information cycle is 1/M of the repetition period, M is an integer.

Protocol Stack structure of the MCCH is shown in FIG. 5, Protocol units of the MCCH listed from top to bottom as follows: the RRC layer, the Radio Link Control layer (RLC), the Medium Access Control layer (MAC) and the Physical Layer (PHY). Wherein, mapping relationship between the logical channel of the MAC layer and the FACH (Forward Access Channel) of the Physical Layer is shown in FIG. 6, in the prior system, the MCCH information i.e. the MBMS control information was mapped to FACH to transmitting.

The RLC layer employs Unacknowledged Mode (UM) to transfer the MCCH information, the data transferring process in the prior UM includes the transferring of a Sender RLC UM entity, and the receiving of a Receiver RLC UM entity. The Protocol Data Unit (PDU) can be transferred in the transfer interval, and the MAC determines the size and number of the PDU within the transfer interval. During the transferring process, the Sender performs segmentation and concatenation on a Service Data Unit (SDU) that the upper layer sends according to the size of the PDU, and the Receiver re-assembles corresponding SDU based on the received PDU. According to the prior art, an out-of-sequence delivery function of the SDU delivery function is added to the RLC, the out-of-sequence delivery function refers to the function of retransferring any assigned PDU has been sent before, according to the instruction.

According to the protocol in the 3GPP TS 25.331, the MCCH configuration information which is also called RLC configuration information is transferred in a System Information Block type 5 or 5bis by the UTRAN. After receiving the MCCH configuration information, the UE receives the corresponding MCCH information according to the Secondary Primary Common Control Physical Channel (Secondary CCPCH), the (FACH) and RLC information configuration Physical Channel, transport Channel (T-CH), and RLC entity in the MCCH configuration information. In prior art, the system information block is used for transferring system information of cell broadcast, according to difference in the logic functions, the system information block can be the scheduling block, the System Information Block type 1, System Information Block type 2, . . . , System Information Block type 5 and 5bis etc. Each system information block corresponds to one value tag which is the version number of the information for determining whether the relevant system information is changed. Generally, once any field of the system information block changes, the value tag will change correspondingly. Wherein, the MCCH configuration information includes diversified configuration information such as out-of-sequence delivery configuration information etc, the system information block is included in the scheduling information of the major information block corresponding to each cell.

When the UE reselects a new cell or the paging received from the UTRAN indicates that the system information of broadcast changes, the UE reads the system information of broadcast. The UE reads the System Information Block type 5 or 5bis on the following conditions: \textcircled{1} when the value tag of the system information block in the scheduling information read by the UE is different with the value tag that the UE stored for the system information block; \textcircled{2} the UE has not stored the system information block and its value tag. Correspondingly, after reading the System Information Block type 5 or 5bis, the UE store the system information block and its corresponding value tag, and re-establish the RLC entity according to the information in the system information block.

When the MCCH configuration information in the System Information Block type 5 or 5bis read by the UE has out-of-sequence delivery configuration information, the UE uses the parameters in the out-of-sequence delivery configuration information to configure the corresponding re-established RLC entity in order to use out-of-sequence delivery function.

### SUMMARY OF THE INVENTION

The embodiment of the present invention provides a method for receiving MBMS control information in order to facilitate a UE to reselect new cell for establishing RLC entity in time, and further guaranteeing correct processing of subsequent messages.

The embodiment of present invention also provides a method for receiving MBMS control information in order to enable a UE to configure or re-establish RLC entity in time when a configure information changes, and further optimizing reestablishment mechanism of RLC entity. The embodiment of present invention also provides a system for receiving MBMS control information and a UE.

A method for receiving MBMS control information includes: a network side transfers a system information block in a broadcast channel, the system information block includes RLC configuration information; a UE selects a new cell, and obtains the RLC configuration information available to the new cell, and re-establishes an RLC receiving entity according to the obtained available RLC configuration information.

A method for receiving MBMS control information includes: a network side transfers a system information block in a broadcast channel, the system information block includes RLC configuration information; a UE receives the RLC configuration information and checks whether there is out-of-sequence delivery configuration information within the RLC configuration information, if there is out-of-sequence delivery configuration information within the RLC configuration information, configures an RLC receiving entity according to the received out-of-sequence delivery configuration information.

A system for receiving MBMS control information includes a network side and a UE, the network side has means configured to transfer a system information block in a broadcast channel, wherein the system information block includes an RLC configuration information; the UE has means configured to obtain the RLC configuration information available to the new cell when the UE selecting a new cell, and re-establish an RLC receiving entity according to the available RLC configuration information, or has means configured to receive the RLC configuration information, if there is out-of-sequence delivery configuration information within the RLC configuration information, configure the RLC receiving entity according to the received out-of-sequence delivery configuration information.

A UE for receiving MBMS control information includes: an obtaining unit for obtaining the RLC configuration information available to the new cell, a receiving unit for receiving the RLC configuration information, an RLC receiving entity unit for re-establishing an RLC receiving entity and configuring the RLC receiving entity; and the RLC receiving entity unit of the UE re-establishes an RLC receiving entity according to the available RLC configuration information, and if there is out-of-sequence delivery configuration information within the RLC configuration information, the RLC receiving entity unit configures the RLC receiving entity according to the out-of-sequence delivery configuration information.

### BRIEF DESCRIPTION OF THE DRAWINGS

FIG. 1 is a schematic diagram illustrating architecture of a radio network that supports Broadcast/Multicast service.

FIG. 2 is a schematic flowchart illustrating operation in MBMS Multicast mode.

FIG. 3 is a schematic flowchart illustrating operation in MBMS Broadcast mode.

FIG. 4 is a schematic diagram illustrating scheduling and transferring of MCCH information.

FIG. 5 is a schematic diagram illustrating a Protocol Stack structure of a MCCH.

FIG. 6 is a schematic diagram illustrating mapping relationship between a logical channel of a MAC layer and a FACH channel of a Physical Layer.

FIG. 7 is a schematic flowchart illustrating a method of the first embodiment in accordance with the present invention.

FIG. 8 is a schematic flowchart illustrating a method of the second embodiment in accordance with the present invention.

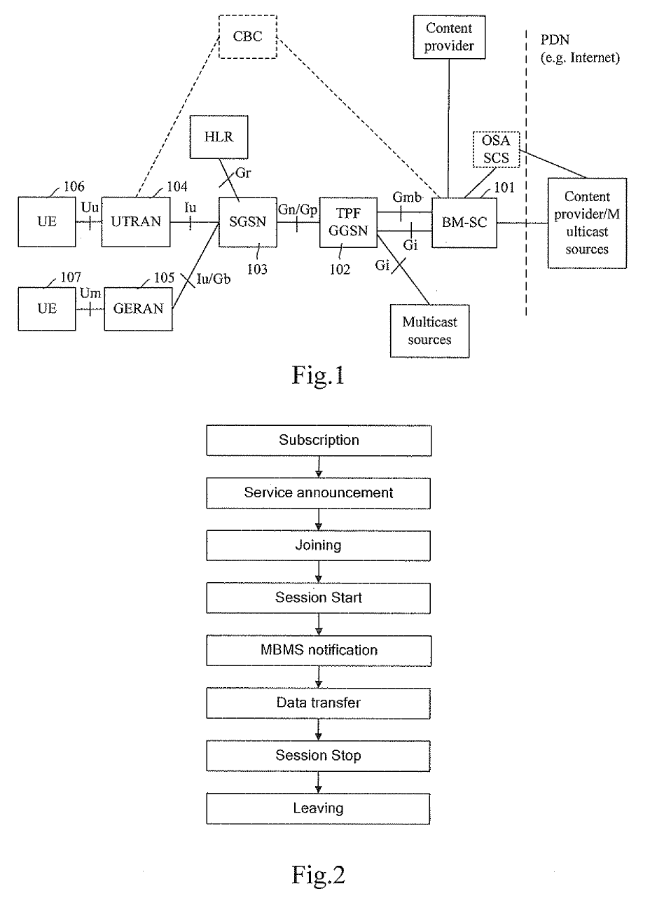

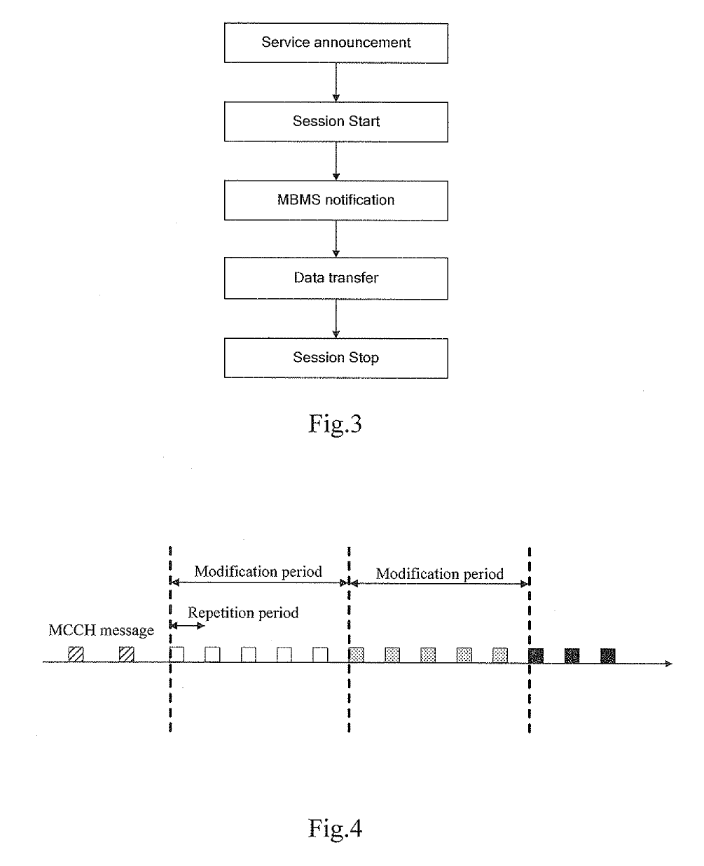

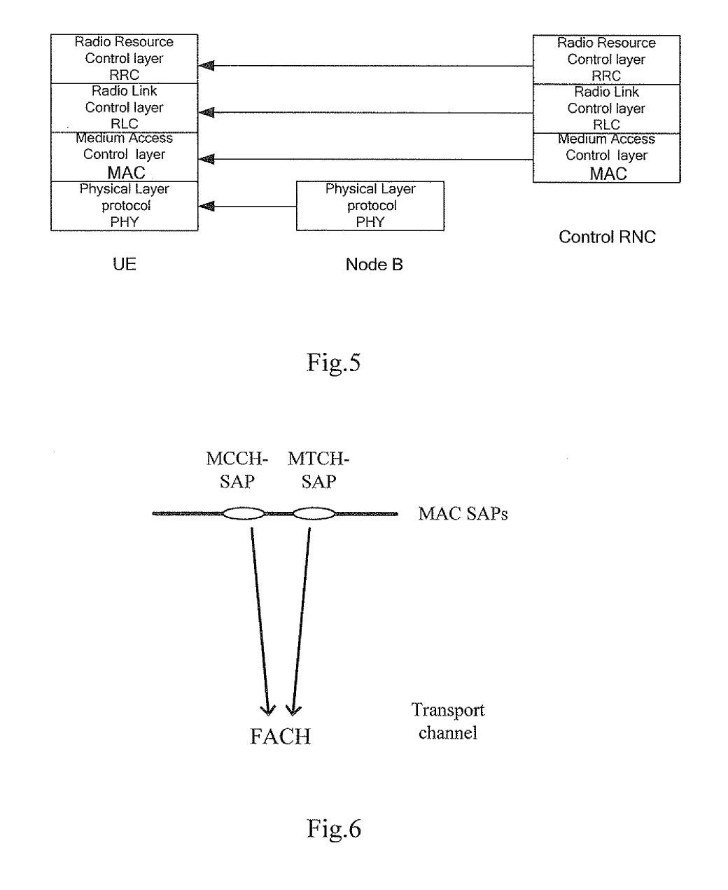

### DETAILED DESCRIPTION OF THE INVENTION

According to the embodiments of the present invention, when the UE reselects the new cell or the out-of-sequence delivery configuration information changes, a receiving entity is re-configured or re-established, for ensuring accuracy of subsequent operations duly and building a preferable receiving entity re-establishment mechanism. As for detailed means of re-establishing receiving entity, it is generally implemented according to the out-of-sequence delivery configuration information, wherein, the out-of-sequence delivery configuration information can be either newly read or saved in advance.

The embodiments of present invention involves three implementation schemes: in the first scheme, after the UE reselects the new cell, the receiving entity will be re-established no matter whether value tag of the system information block currently read is identical or not. In the second and the third schemes, under the condition that the UE does not change the cell, the receiving entity will be re-established only when out-of-sequence delivery configuration information changes, wherein, difference between the second and the third schemes is that: means adopted for checking whether out-of-sequence delivery configuration information changes are different. The current value tag is corresponding to the entire system information block, the out-of-sequence delivery configuration information is a message contained in the system information block, and therefore, value tag changes will not always indicate the out-of-sequence delivery configuration information changes. Therefore, the second scheme specially sets a value tag for out-of-sequence delivery configuration information, in order to indicate whether the out-of-sequence delivery configuration information changes. In the third scheme, the UE compares the received out-of-sequence delivery configuration information with the out-of-sequence delivery configuration information saved in the UE, to determine whether the out-of-sequence delivery configuration information changes.

All of the three schemes above have their detailed way for implementing, for example: RLC receiving entity is re-configured or re-established based on the conventional standardized procedures, but corresponding amendments is executed on operating conditions or relevant judgments, therefore, amendment on existing protocols is less. A new re-establishment means in special environment to cancel some unnecessary processing steps and simplify complexity of the procedure.

Different conditions for diversified schemes in accordance with the embodiment of the present invention will be described in more detail hereinafter with the reference to the drawings and embodiments.

### A FIRST EMBODIMENT

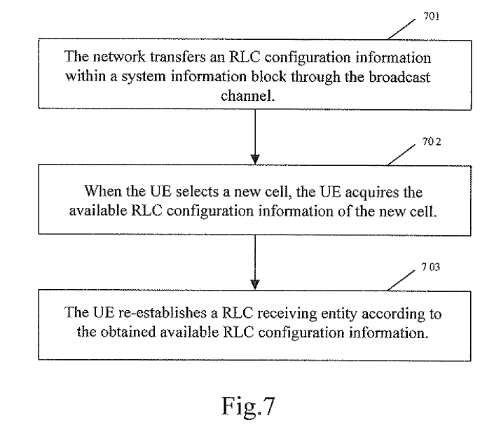

In this preferred embodiment of the present invention, a UE reselected a new cell and the procedure is implemented according to the protocol in the 3GPP TS 25.331. Now referring to FIG. 7, the method for receiving MBMS information according to this preferred embodiment includes the following steps:

Step 701: The network transfers RLC configuration information within a system information block through the broadcast channel.

Generally, a UTRAN makes the out-of-sequence delivery configuration information in a System Information Block type 5 or 5bis, and transfers it through the broadcast channel.

Step 702: When the UE selects a new cell, the UE acquires the available RLC configuration information of the new cell. The available RLC configuration information refers to the information read from the system information block currently, or the information in the system information block stored in the current UE.

Generally, when the UE selects a new cell, the UE reads a Master Information Block corresponding to the new cell, and reads a system information block and a scheduling block according to scheduling information in the Master Information Block or the scheduling information stored in the Master Information Block.

For the currently received System Information Block type 5 or 5bis, the UE compares a value tag of the system information block read from the scheduling information with the value tag stored in its VALUE_TAG variable for the system information block; if these value tags are different or there is no corresponding system information block stored in the UE, the value tag read from the scheduling information is stored in the VALUE_TAG variable of the UE. The system information block is read and stored, and the RLC configuration information in the system information block currently read is used as the RLC configuration information. If the value tags are identical, the UE makes the RLC configuration information in the system information block stored in itself as the available RLC configuration information.

In this step, the step of the UE comparing a value tag of the system information block read from the scheduling information with the value tag stored in its VALUE_TAG variable for the system information block may be omitted. Then the procedure is that: when the UE selects a new cell, the UE reads RLC configuration information of the current cell.

That is, if the currently received system information block is a System Information Block type 5 or 5bis, the UE reads value tag from the current scheduling information and stores it into the variable VALUE_AG of the UE, and reads and stores the current system information block. In this embodiment, the RLC configuration information read from the system information block is the available RLC configuration information of the current UE. Step 703: The UE re-establishes an RLC receiving entity according to the obtained available RLC configuration information. In detail, after the UE selected a new cell, if the System Information Block type 5 or 5bis read in advance or stored in the UE includes the out-of-sequence delivery configuration information, the UE re-configures a RLC UM receiving entity according to the out-of-sequence delivery configuration information, i.e., re-establishing corresponding RLC receiving entity.

The process of re-establishing RLC receiving entity further includes the following steps: \textcircled{1} reset the state variable with the initial value. Wherein, the state variable refers to a VR(UOH), which is used to indicate the largest sequence number of the PDU that current RLC receiving entity has received. Generally, the value of VR(UOH) is the upper limit of the sequence number of the PDUs, the lower limit of sequence number of the received PDU is the VR(UOH) minus the Out-of-Sequence Delivery receiving Window size. \textcircled{2} set configure value with the configure parameters, which is actually setting Out-of-Sequence Delivery receiving Window size, the Out-of-Sequence Delivery receiving Window is set as corresponding parameter values in the system information block read in advance or the system information block stored in the UE. \textcircled{3} set a Hyper Frame Number with a higher layer configuration value. \textcircled{4} discard all Unacknowledged Mode Data (UMD) PDUs in the RLC receiving entity. \textcircled{5} If the timer Timer_OSD has started, cancel the timer. The implement method for re-establishing RLC receiving entity is the prior art, and no details will be discussed hereinafter.

### A SECOND EMBODIMENT

This preferred embodiment is similar with preferred embodiment one, the only difference is that: the re-establishing RLC receiving entity further includes following steps: upon the RLC receiving entity being re-established, making the first PDU received by the re-established RLC receiving entity as the first PDU received by the RLC receiving entity; moreover, setting the current VR(UOH) as sequence number of current PDU decreased by one after receiving the first PDU.

### A THIRD EMBODIMENT

Processing steps in this preferred embodiment are similar with those of the first embodiment, the difference is that: because the UE must re-establish RLC receiving entity after reselecting a cell, the preferred embodiment no longer needs to consider processing the value tag, which means that it is unnecessary to check whether the value tag currently read is identical with the value tag saved in the UE, and unnecessary to check whether the UE has saved corresponding value tag. Thus, Step 702 turns into:

Step 702′: when a new cell is selected, the UE reads RLC configuration information of current cell.

Generally, after selecting a new cell, the UE needs to read Master Information Block that is corresponding to the cell, and then read system information block and block scheduling according to the schedule message in the Master Information Block or the schedule message saved in the Master Information Block.

If the currently received system information block is System Information Block type 5 or 5bis, then the UE reading value tag from current schedule message and saving it into variable VALUE_TAG of UE, and reading and saving the current system information block. In this embodiment, the RLC configuration information in the read system information block is just the current applicable RLC configuration information.

Correspondingly, in Step 703, if the System Information Block type 5 or 5bis currently read contains out-of-sequence delivery configuration information, then the UE re-establishing corresponding RLC receiving entity according to the out-of-sequence delivery configuration information.

### A FOURTH EMBODIMENT

This preferred embodiment is similar with the third embodiment, the only difference is that: said re-establishing RLC receiving entity further includes the following steps: upon RLC receiving entity is re-established, the first PDU received by the re-established RLC entity is made as the first PDU received by the RLC entity; moreover, after the first PDU is received, sequence number of current PDU decreased by one is set as the current VR(UOH).

In the above preferred embodiments and this preferred embodiment, after reselecting a new cell, the UE uses the out-of-sequence delivery configuration information read in advance, or the out-of-sequence delivery configuration information stored in the UE to re-establish MCCH RLC entity, which can not only avoid inaccurate RLC SDU resulting from re-establishment of the PDU that includes the new cell MCCH information and the PDU that contains the original cell MCCH information, but also clear the buffer in time.

In the above preferred embodiments and this embodiment, all the out-of-sequence delivery configuration information are placed within System Information Block type 5 or 5bis for transferring, in practical application, the out-of-sequence delivery configuration information can also be placed within other type of system information block for transferring. Besides, once the UE decides to re-establish RLC entity, the process can be implemented within the current modification period, that is: re-establishment is implemented immediately after acquiring the out-of-sequence delivery configuration information of the new cell. The reestablishment can be implemented in the next modification period or in the period instructed by the network.

### A FIFTH EMBODIMENT

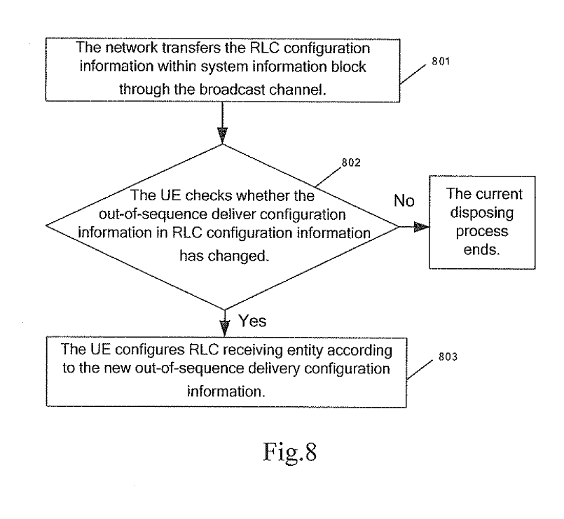

In this preferred embodiment, When the UE does not re-select a new cell. RLC receiving entity re-configuring or re-establishing can be implemented only when the out-of-sequence delivery configuration information changes. Since the value tag in prior art is used for identifying whether some information in the entire system information block has changed, in this case, it is difficult to exactly know whether the out-of-sequence delivery configuration information has changed, therefore, this preferred embodiment configuring an exclusive value tag for the out-of-sequence delivery configuration information to especially indicate whether content of the out-of-sequence delivery configuration information has changed, the parameter can be called as out-of-sequence message value tag. Once content of the out-of-sequence delivery configuration information changes, the out-of-sequence message value tag that is corresponding to out-of-sequence delivery configuration information will be accordingly modified into different values. As shown in FIG. 8, the method for receiving MBMS information in this preferred embodiment includes the following steps:

Step 801: The network transfers the RLC configuration information within the system information block through the broadcast channel.

Generally, the UTRAN transfers the out-of-sequence delivery configuration information within the System Information Block type 5 or 5bis through the broadcast channel. When the content of the System Information Block type 5 or 5bis changes, the value tag corresponding to the system information block is correspondingly modified; when content of the out-of-sequence delivery configuration information changes, the configured out-of-sequence message value tag is correspondingly modified.

Step 802˜803: the UE checks whether the out-of-sequence delivery configuration information in RLC configuration information has changed, if the out-of-sequence delivery configuration information in RLC configuration information has changed, then RLC receiving entity is configured according to the new out-of-sequence delivery configuration information; otherwise, the current disposing process ends.

In this preferred embodiment, the step of checking whether the out-of-sequence delivery configuration information has changed includes: the UE checks whether the out-of-sequence message value tag has changed.

As for the currently received System Information Block type 5 or 5bis, the UE will compare value tag of the system information block read from the scheduling information with the value tag stored in its VALUE_TAG variable for the system information block; if these value tags are different or there is no corresponding system information block stored in the UE, then the UE stores the value tag that is read from the scheduling information into variables VALUE_TAG of the UE, reads and stores the system information block, and then makes the information in the system information block currently read as available RLC configuration information; otherwise if the value tags are identical, then the UE can make the information in the system information block it stored as available RLC configuration information.

As for out-of-sequence delivery configuration information in the system information block, the UE compares out-of-sequence message value tag corresponding to the out-of-sequence delivery configuration information and read from the system information with the out-of-sequence message value tag stored in the UE for the out-of-sequence delivery configuration information; if these out-of-sequence message value tags are different, then the UE stores the out-of-sequence message value tag that is read in advance into its corresponding variables, and configures RLC receiving entity according to parameters of the out-of-sequence delivery configuration information that is read in advance; otherwise if these out-of-sequence message value tags are identical, then the UE ignores all received out-of-sequence delivery configuration information.

The above checking processes of value tag corresponding to the system information block mainly aims to accord with regulations of standard protocols in prior art, in practical application, the operation is unnecessary. Of course, the UE can first check whether content of the system information block has changed, if the content of the system information block has changed, then the UE further checks whether content of the out-of-sequence delivery configuration information has changed, otherwise, the UE can directly end the processing steps.

The step of configuring RLC receiving entity in Step 803 of this embodiment refers to re-configuring RLC receiving entity and updating configuration parameters according to the updated out-of-sequence delivery configuration information parameter, for instance, changing size of the parameter Out-of-Sequence Delivery Storage Window. Correspondingly, in the RLC receiving entity, if value of the newly configured parameter of the Out-of-Sequence Delivery Storage Window is smaller than that of the original Out-of-Sequence Delivery Storage Window parameter, then the PDU out of the window of the RLC receiving entity buffer is discarded. Wherein, the PDU out of the window refers to the PDU whose sequence number (SN) is outside the scope of: VR(UOH) minus size of the Out-of-Sequence Delivery Storage Window<SN<VR(UOH).

In this preferred embodiment, value of the configured out-of-sequence message value tag can be any successive integer, e.g. 1 to 8, and initial value can be a random number, each time when the out-of-sequence delivery configuration information changes, value of the out-of-sequence message value tag increases by 1 and then gets module.

### A SIXTH EMBODIMENT

Processing steps in this preferred embodiment are similar to those of the fifth embodiment, the difference is that: in this preferred embodiment, the step of configuring RLC receiving entity in Step 803 refers to re-establishing RLC receiving entity. Wherein, the step of re-establishing RLC receiving entity process further includes following steps: \textcircled{1} reset the state variable with the initial value. Wherein, the state variable refers to VR(UOH), which is used to indicate the largest sequence number of the PDU that current RLC entity has received. Generally, value of VR (UOH) is the upper limit of sequence number of the PDU, while VR(UOH) minus size of the Out-of-Sequence Delivery Storage Window equals to lower limit of sequence number of the received PDU. \textcircled{2} set configure value with the configure parameters, which is actually setting size of the Out-of-Sequence Delivery Storage Window, and set current size of the Out-of-Sequence Delivery Storage Window with corresponding parameter values in the system information block read in advance or the stored system information block. \textcircled{3} set Hyper Frame Number with higher layer configuration value. \textcircled{4} discard all UMD PDUs in the RLC entity. \textcircled{5} If the timer Timer_OSD has started, then the timer is stopped.

### A SEVENTH EMBODIMENT

Processing steps in this preferred embodiment are similar with those of the sixth embodiment, the only difference is that: the step of re-establishing RLC receiving entity further includes the following steps: after RLC receiving entity is re-established, the first PDU received by the re-established RLC entity is made as the first PDU received by the RLC entity; moreover, after the first PDU is received, the current VR(UOH) is set as sequence number of current PDU decreased by one.

In the fifth embodiment and the sixth embodiment and the seventh embodiment, only when content of the out-of-sequence delivery configuration information changes, the out-of-sequence delivery configuration information is processed, and RLC entity is re-configured or re-established according to the out-of-sequence delivery configuration information read in advance, which can avoid the case that when content change of other information in the system information block that contains out-of-sequence delivery configuration information results in re-establishing or re-configuring of RLC receiving entity. Wherein, as for whether re-configuring RLC receiving entity or re-establishing RLC receiving entity can be determined through UTRAN sending corresponding identifier to the UE for instructing the UE to re-configure or re-establish RLC receiving entity.

In the fifth embodiment and the sixth embodiment and the seventh embodiment, all the out-of-sequence delivery configuration information transferred within the System Information Block type 5 or 5bis, in practical application, the out-of-sequence delivery configuration information can also transferred within other types of system information block. Besides, while the UE is determining re-configuring or re-establishing RLC entity, the re-configuring or re-establishing process can be implemented in the modification period, i.e. upon getting the out-of-sequence delivery configuration information, the UE implements the re-configuring or re-establishing process immediately; or postpones the re-configuring or re-establishing operation to next modification period; or decides the implementing time according to instruction of the network.

### AN EIGHTH EMBODIMENT

In this preferred embodiment, for the UE that has not reselected cell, RLC receiving entity re-configuring or re-establishing can be implemented only when the out-of-sequence delivery configuration information changes. The embodiment directly compares parameter values of the out-of-sequence delivery configuration information that the UE currently read with that of the out-of-sequence delivery configuration information stored in the UE to determine whether the out-of-sequence delivery configuration information has changed. Wherein, the changes of the out-of-sequence delivery configuration information can be changes of one of the parameters or several of the parameters.

Actually, processing steps in this preferred embodiment are similar to those of the fifth embodiment; the difference is the checking process in Step 802. In this embodiment, the step of checking whether the out-of-sequence delivery configuration information has changed includes: the UE checks whether all parameters of the out-of-sequence delivery configuration information that is read is same with those of the out-of-sequence delivery configuration information stored in the UE, if they are different, then configures RLC receiving entity according to the out-of-sequence delivery configuration information read in advance; otherwise, the UE ends the current disposing process.

Wherein, the UE reads system information block from the scheduling information first, and then reads out-of-sequence delivery configuration information from the system information of the system information block.

In this preferred embodiment, the step of configuring RLC receiving entity in Step 803 refers to re-configuring RLC receiving entity according to the updated out-of-sequence delivery configuration information parameter, for instance, changing size of the parameter Out-of-Sequence Delivery Storage Window. Correspondingly, in the RLC receiving entity, if the value of the newly configured parameter of the Out-of-Sequence Delivery Storage Window is smaller than that of the original Out-of-Sequence Delivery Storage Window parameter, then the PDU out of the window of the RLC receiving entity buffer is discarded. Wherein, the PDU beyond the window refers to: the PDU whose sequence number (SN) is outside the scope of VR(UOH)—size of the Out-of-Sequence Delivery Storage Window<SN<VR(UOH).

### A NINTH EMBODIMENT

Processing steps in this preferred embodiment are similar with those of the eighth embodiment, the difference is that: the step of configuring RLC receiving entity in this preferred embodiment refers to re-establishing RLC receiving entity. Wherein, the step of re-establishing RLC receiving entity process further includes the following steps: \textcircled{1} reset the state variable with the initial value. Wherein, the state variable refers to VR(UOH), which is used to indicate the largest sequence number of the PDU that current RLC entity has received. Generally, value of VR(UOH) is the upper limit of sequence number of the PDU, while VR(UOH) minus size of the Out-of-Sequence Delivery Storage Window equals to lower limit of sequence number of the received PDU. \textcircled{2} set configure value with the configure parameters, which is actually setting size of the Out-of-Sequence Delivery Storage Window, and setting current size of the Out-of-Sequence Delivery Storage Window with corresponding parameter values in the system information block read in advance or the stored system information block. \textcircled{3} set Hyper Frame Number with higher layer configuration value. \textcircled{4} discard all UMD PDUs in the RLC entity. \textcircled{5} If the timer Timer_OSD has started, then the timer is stopped.

### A TENTH EMBODIMENT

Processing steps in this preferred embodiment are similar to those of the ninth embodiment, the only difference is that: the step of re-establishing RLC receiving entity further includes the following steps: upon RLC receiving entity is re-established, the first PDU received by the re-established RLC entity is made as the first PDU received by the RLC entity; moreover, upon the first PDU is received, the current VR (UOH) is set as sequence number of current PDU decreased by one.

In the eighth embodiment and the ninth embodiment and the tenth embodiment, only when content of the out-of-sequence delivery configuration information read in advance changes, the out-of-sequence delivery configuration information is processed, and the RLC entity is re-configured or re-established according to the configuration information, which can avoid the case that when content change of other information in the system information block that contains out-of-sequence delivery configuration information results in re-establishing or re-configuring of RLC receiving entity. Wherein, as for whether re-configuring RLC receiving entity or re-establishing RLC receiving entity can be determined by UTRAN sending corresponding identifier to the UE and instructing the UE to re-configure or re-establish RLC receiving entity.

In the eighth embodiment and the ninth embodiment and the tenth embodiment, all the out-of-sequence delivery configuration information transferred within the System Information Block type 5 or 5bis, in practical application, the out-of-sequence delivery configuration information can also transferred within other types of system information block. Besides, while the UE is determining re-configuring or re-establishing RLC entity, the re-configuring or re-establishing process can be implemented in the modification period, i.e. upon getting the out-of-sequence delivery configuration information, the UE implements the re-configuring or re-establishing process immediately; or postpones the re-configuring or re-establishing operation to next modification period; or decides the implementing time according to instruction of the network.

The premises of embodiments from the fifth embodiment to the tenth embodiment are that: the RLC configuration information contains out-of-sequence delivery configuration information, if without the premise, then, the following checking process should be made after the UE receives RLC configuration information: the UE determines whether the RLC configuration information contains out-of-sequence delivery configuration information, if the RLC configuration information contains out-of-sequence delivery configuration information, then continues to check whether the out-of-sequence delivery configuration information has changed, otherwise, directly ends the process step. Of course, there is one special situation: once the UE receives the out-of-sequence delivery configuration information, then the RLC receiving entity is re-configured or re-established no matter whether the out-of-sequence delivery configuration information has changed or not, in this case, as long as the UE verifies that the RLC configuration information contains out-of-sequence delivery configuration information, the re-configuring or re-establishing operation will be implemented instead of continuing to check whether the out-of-sequence delivery configuration information has changed. The detailed means to implement RLC receiving entity re-configuring or re-establishing operations is just the same with that in embodiments from the fifth embodiment to the tenth embodiment.

The RLC receiving entity in all preferred embodiments above can be MCCH RLC UM entity, anyhow, the forgoing discussion discloses and describes merely preferred embodiments of the present invention, and is not used to limit protection scope of the present invention.

What is claimed is:

1. A method for receiving Multimedia Broadcast/Multicast Service (MBMS) control information, comprising:
transferring, by a network side, a system information block in a broadcast channel, the system information block including Radio Link Control Layer (RLC) configuration information;
selecting a new cell, obtaining the available RLC configuration information which is available to the new cell, and re-establishing an RLC receiving entity according to the available RLC configuration information by a User Equipment (UE).

2. The method of claim 1, if the system information block currently received contains the RLC configuration information, reading and storing the current system information block, and making the RLC configuration information in the system information block as the available RLC configuration information.

3. The method of claim 1, if the currently received system information block contains RLC configuration information, checking whether content of the system information block changes, if changes, reading and storing the current system information block, and making the RLC configuration information in the system information block as the available RLC configuration information; if not changes, making the RLC configuration information stored in the system information block as the available RLC configuration information.

4. The method of claim 3, wherein the procedure of checking whether the content of the system information block changes comprises: checking whether a value tag corresponding to the system information block currently read is the same with a value tag stored by UE itself, if same, not changing the content of the system information block; otherwise, changing content of the system information block.

5. The method of claim 1, wherein the available RLC configuration information comprises out-of-sequence delivery configuration information.

6. The method of claim 5, wherein the procedure of re-establishing RLC receiving entity comprises: when obtaining the available RLC configuration information of the new cell, the UE re-establishing the RLC receiving entity immediately or in a modification period next to the modification period which the UE obtaining the available RLC configuration information; or the UE determining the time to re-establish the RLC receiving entity according to an instruction sent from the network side.

7. The method of claim 6, wherein the procedure of re-establishing the RLC receiving entity comprises: checking whether a timer starts, if the timer starts, stopping the timer; otherwise, leaving the timer alone.

8. A method for receiving MBMS control information, comprising:
transferring, by a network side, a system information block in a broadcast channel, the system information block including Radio Link Control Layer (RLC) configuration information;
receiving, a User Equipment (UE), the RLC configuration information, and if there is out-of-sequence delivery configuration information within the RLC configuration information, configuring an RLC receiving entity according to the received out-of-sequence delivery configuration information.

9. The method of claim 8, wherein the procedure of the UE receiving the RLC configuration information and configuring the RLC receiving entity further comprises:
if the out-of-sequence delivery configuration information changes, configuring the RLC receiving entity according to the received new out-of-sequence delivery configuration information.

10. The method of claim 9, further comprising: setting an out-of-sequence message value tag corresponding to the out-of-sequence delivery configuration information;
wherein in the procedure of the UE receiving the RLC configuration information and configuring an RLC receiving entity, if the out-of-sequence message value tag currently read is same with an out-of-sequence message value tag in the corresponding out-of-sequence delivery configuration information stored in the UE, the out-of-sequence delivery configuration information is not changed; otherwise, the out-of-sequence delivery configuration information is changed.

11. The method of claim 9, wherein in the procedure of the UE receiving the RLC configuration information and configuring an RLC receiving entity, if the out-of-sequence delivery configuration information currently read is the same with parameter values of out-of-sequence delivery configuration information stored in the UE, the out-of-sequence delivery configuration information is not changed; otherwise the out-of-sequence delivery configuration information is changed.

12. The method of claim 10, when the out-of-sequence delivery configuration information changes, the procedure of the UE receiving the RLC configuration information and configuring an RLC receiving entity further comprises: storing the out-of-sequence message value tag currently read.

13. The method of claim 8, wherein the procedure of resetting the RLC receiving entity comprises: upon getting the out-of-sequence delivery configuration information, the UE immediately resetting a configuration parameter of the RLC receiving entity; or, resetting the configuration parameter of the RLC receiving entity in a modification period next to the one in which the UE obtaining the out-of-sequence delivery configuration information; or, the UE determining a time to reset the configuration parameter of the RLC receiving entity according to instruction sent from the network.

14. The method of claim 13, wherein the re-configuring parameter of the RLC receiving entity is the size of Out-of-Sequence Delivery Storage Window; upon setting the parameter, further comprising: checking whether the size of the updated Out-of-Sequence Delivery Storage Window is smaller than that of before updating, if smaller, discarding the Protocol Data Unit (PDU) whose sequence number is out of the Out-of-Sequence Delivery Storage Window in RLC receiving entity buffer.

15. The method of claim 8, wherein the procedure of configuring RLC receiving entity comprises: re-establishing the RLC entity according to the received out-of-sequence delivery configuration information.

16. The method of claim 15, wherein the procedure of re-establishing the RLC receiving entity comprises: upon getting the out-of-sequence delivery configuration information, the UE immediately starting re-establishing the RLC receiving entity; or, re-establishing the RLC receiving entity in the modification period next to the one in which the UE obtaining the out-of-sequence delivery configuration information; or, the UE determining the time to re-establish the RLC receiving entity according to the instruction sent from the network.

17. The method of claim 15, wherein the step of re-establishing the RLC receiving entity comprises: resetting a state variable with an initial value; setting a configure value with a configure parameter; setting Hyper Frame Number with a higher layer configuration value; discarding all Unacknowledged Mode Data (UMD) PDUs in the RLC entity.

18. The method of claim 8, wherein the system information block is System Information Block type 5, or 5bis.

19. A system for receiving Multimedia Broadcast/Multicast Service (MBMS) control information comprising a network side and a User Equipment (UE),
wherein the network side has means configured to transfer a system information block in a broadcast channel, the system information block includes Radio Link Control Layer (RLC) configuration information;
the UE has means configured to obtain the RLC configuration information available to the new cell when the UE selecting a new cell, and re-establish an RLC receiving entity according to the available RLC configuration information, or receive the RLC configuration information, if there is out-of-sequence delivery configuration information within the RLC configuration information, configure the RLC receiving entity according to the received out-of-sequence delivery configuration information.

20. A User Equipment (UE) for receiving Multimedia Broadcast/Multicast Service (MBMS) control information comprising: an obtaining unit for obtain the RLC configuration information available to the new cell, a receiving unit for receive the RLC configuration information, an RLC receiving entity unit for re-establishing an RLC receiving entity and configuring the RLC receiving entity;
wherein the RLC receiving entity unit of the UE re-establishes the RLC receiving entity according to the available RLC configuration information, and if there is out-of-sequence delivery configuration information within the RLC configuration information, the RLC receiving entity unit configures the RLC receiving entity according to the out-of-sequence delivery configuration information.
